(19) United States
(12) Patent Application Publication
(10) Pub. No.: US 2015/0046633 A1
(43) Pub. Date: Feb. 12, 2015

(54) CACHE CONTROL METHOD AND STORAGE DEVICE

(71) Applicant: KABUSHIKI KAISHA TOSHIBA, Tokyo (JP)

(72) Inventors: Tetsuo Kuribayashi, Yokohama-shi (JP); Hironori Kanno, Fussa-shi (JP); Nobuhiro Sugawara, Yokohama-shi (JP); Yoshinori Inoue, Kawasaki-shi (JP); Yasuyuki Nagashima, Yokohama-shi (JP)

(73) Assignee: KABUSHIKI KAISHA TOSHIBA, Tokyo (JP)

(21) Appl. No.: 14/161,574

(22) Filed: Jan. 22, 2014

Related U.S. Application Data
(60) Provisional application No. 61/864,979, filed on Aug. 12, 2013.

(51) Int. Cl. G06F 12/02; G06F 12/08; G06F 12/12

(52) U.S. Cl. CPC G06F 12/0246; G06F 12/12; G06F 12/0808
USPC 711/103; 711/133; 711/135

(57) ABSTRACT

According to one embodiment of the present invention, a cache control method of a storage device is provided, the storage device including: a storage unit that stores data, and a buffer memory having a first cache area and a second cache area serving as a cache of the storage unit. The cache control method according to the embodiment includes: storing data read from the storage unit in the first cache area in response to a read command from a host; moving retried data, on which a read retry has occurred upon the readout from the storage unit, to the second cache area from the first cache area in order that the retried data amount in the second cache area is not more than a predetermined data amount; and transferring data in the first cache area or the second cache area to the host.

### CROSS-REFERENCE TO RELATED APPLICATIONS

This application is based upon and claims the benefit of priority from Provisional Patent Application No. 61/864,979, filed on Aug. 12, 2013; the entire contents of which are incorporated herein by reference.

### FIELD

Embodiments of the present invention relate to a cache control method and a storage device.

### BACKGROUND

When failing to read data recorded on a medium, a current HDD device performs a retry action of reading again the data that is read unsuccessfully (this action is hereinafter referred to as read retry). Upon the read retry, the HDD device needs to again position a reading head to the portion to be read, and waits until the corresponding portion on the rotating medium arrives at the reading head. When the data cannot be read even by the retry, the HDD device repeats the read retry action until the data is read within an allowed number of times of retry. Therefore, it can be said that the occurrence of the read retry significantly deteriorates the reading speed of the HDD device.

On the portion where the read retry is required, magnetic information is more likely to be damaged by some reason. The reason is because the number of total tracks in the device increases year after year due to the increase in the recording density, and the increase in the track density brings adverse effect such that, when many writing actions are performed to the same track, the magnetic recording to the peripheral tracks is faded due to the magnetism caused upon the writing action.

On the other hand, the HDD device includes a cache memory in order to enhance a data readout performance with a host device, and executes the data readout via the cache memory. The data reading speed of the HDD device is increased by temporarily storing read data into the cache memory.

### BRIEF DESCRIPTION OF THE DRAWINGS

FIG. 1 is a diagram illustrating a configuration of a storage device according to an embodiment.

FIG. 2 is a diagram illustrating a simplified configuration of the storage device according to the embodiment.

FIG. 3 is a flowchart for describing a cache control method according to the embodiment.

FIG. 4 is a flowchart for describing a detailed operation when data to which retry information is set in a work area is moved to a second cache according to the embodiment.

FIG. 5 is a view illustrating a first state of a first cache and the second cache according to the embodiment.

FIG. 6 is a view illustrating a second state of the first cache and the second cache according to the embodiment.

FIG. 7 is a view illustrating a third state of the first cache and the second cache according to the embodiment.

FIG. 8 is a view illustrating a fourth state of the first cache and the second cache according to the embodiment.

### DETAILED DESCRIPTION

According to one embodiment of the present invention, a cache control method of a storage device is provided, the storage device including: a storage unit that stores data, and a buffer memory having a first cache area and a second cache area serving as a cache of the storage unit. The cache control method according to the embodiment includes: storing data read from the storage unit in the first cache area in response to a read command from a host; moving retried data, on which a read retry has occurred upon a readout from the storage unit, to the second cache area from the first cache area in order that the retried data amount in the second cache area is not more than a predetermined data amount; and transferring data in the first cache area or the second cache area to the host.

The cache control method and the storage device according to the embodiment will be described below in detail with reference to the accompanying drawings. The present invention is not limited to the embodiment.

### Embodiment

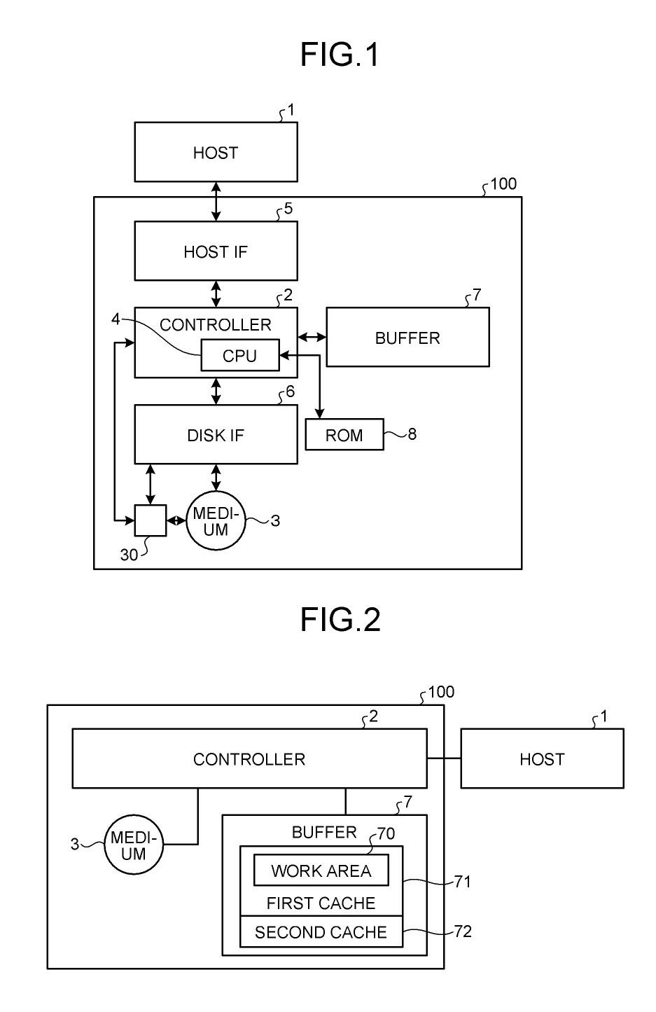

FIG. 1 is a view illustrating a configuration of a storage device 100 according to the embodiment. The storage device 100 is a magnetic disk (HDD) device, for example. The storage device 100 includes a controller 2, a medium 3 (storage unit) such as a disk, a spindle motor 30, a buffer 7 (buffer memory), a host IF (interface) 5, a disk IF 6, and ROM 8, and is connected to a host 1 via the host IF 5. The controller 2 has a CPU 4. The CPU 4 executes control for a cache area in the buffer 7 in accordance with firmware stored in the ROM 8, for example. The medium 3 that is a magnetic disk, for example, is driven by the spindle motor 30. The spindle motor 30 is controlled by the controller 2.

For describing the present embodiment, FIG. 2 illustrates a simplified configuration of the storage device 100. FIG. 2 illustrates the cache area in the buffer 7 in detail. The buffer 7 is volatile memory such as DRAM, and can be accessed with higher speed than the medium 3. Notably, the buffer 7 may be non-volatile memory such as NAND memory.

The buffer 7 includes a first cache 71 and a second cache 72 as the cache area. The first cache 71 stores read data/look-ahead data as a cache. The first cache 71 also includes a work area 70 used for transmission and reception of data to the host 1. Specifically, the work area 70 is a part of the first cache 71. The size of the work area 70 in the first cache 71 is appropriately set by the controller 2. The second cache 72 is for storing data (retried data) from a sector where the read retry has occurred upon the readout from the medium 3. When an empty area for setting the work area 70 is absent from the first cache 71, the data in the first cache 71 is invalidated in the order from the data having the old last read time. However, since the second cache 72 is provided, the retried data can be managed in the buffer 7 with the higher priority than other data. When the retried data is held in the first cache 71, the retried data that is invalidated because of the old last read time is separately managed by the second cache 72, so that this retried data is not invalidated but can be left. The first cache 71 and the second cache 72 use the memory area of the buffer 7, and the size of the second cache 72 is set to be a predetermined size. The controller 2 (CPU 4) secures the work area 70, and manages the data in the first cache 71 and the second cache 72.

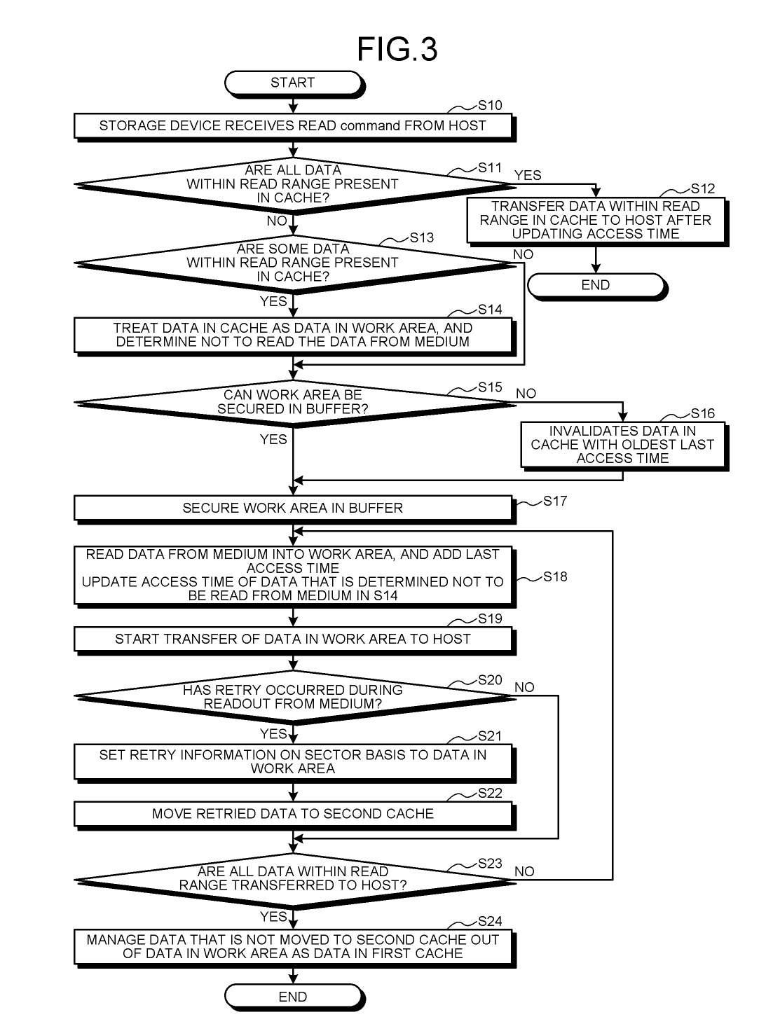

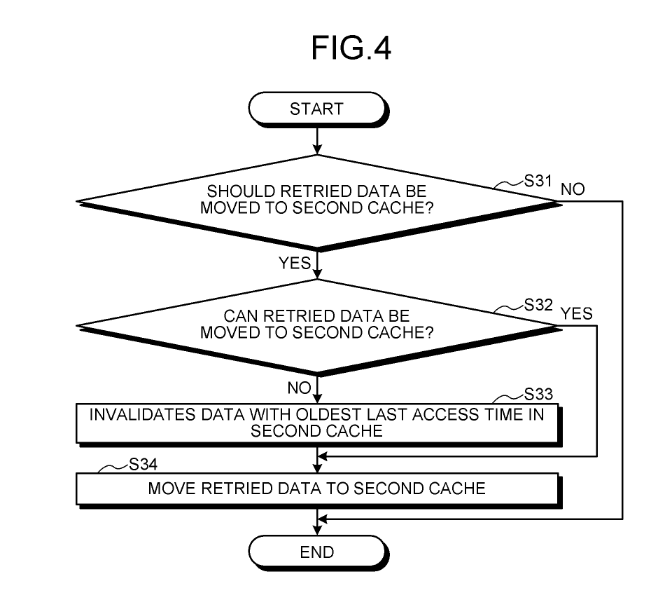

The cache control method according to the present embodiment will be described below with reference to flowcharts in FIGS. 3 and 4. The cache control excluding the data transfer to the host 1 is basically executed by the controller 2 (CPU 4) according to the firmware.

When the storage device 100 receives READ command from the host 1 (FIG. 3: step S10), the controller 2 (CPU 4) determines whether the data in READ range designated by the READ command is present anywhere in the first cache 71 and the second cache 72 (step S11). The data within the READ range designated by the READ command may be dispersed in the cache 71 and the second cache 72. When the data within the READ range is present anywhere in the first cache 71 or the second cache 72 (step S11: Yes), the controller 2 (CPU 4) updates the access (read) time added to the data within the READ range in the first cache 71 or the second cache 72, and then, transfers the data to the host 1 (step S12).

When not all the data within the READ range is present in the first cache 71 or the second cache 72 (step S11: No), the controller 2 determines whether some data within the READ range are present anywhere in the first cache 71 or the second cache 72 (step S13). When some data within the READ range are present anywhere in the first cache 71 or the second cache 72 (step S13: Yes), the data within the READ range present in the first cache 71 and the second cache 72 is treated in the same manner as the data that is to be read from the medium to the work area 70 and transferred to the host. Therefore, this data is determined not to be read from the medium 3 (step S14).

Thereafter, the controller 2 (CPU 4) determines whether the work area 70 for temporarily securing the data read from the medium 3 in the buffer 7 can be secured only by the empty area in the first cache 71, i.e., only by the area where significant data is not stored (step S15). When the data within the READ range is not present at all in the first cache 71 and the second cache 72 in step S13 (step S13: No), the controller 2 (CPU 4) also proceeds to step S15. When the controller 2 (CPU 4) determines that the work area 70 cannot be secured only by the empty area in the first cache 71 (step S15: No), it invalidates the data having the oldest last access time in the first cache 71 until to be able to secure work area (step S16).

When the work area 70 can be secured in the empty area in the first cache 71 (step S15: Yes), or after step S16, the work area 70 is secured in the first cache 71 (step S17). Then, the data is read into the work area 70 from the medium 3 (step S18). In this case, the controller 2 (CPU 4) adds the last access (read) time to the data read from the medium 3. In addition, the controller 2 (CPU 4) updates the access (read) time added to some data, which are determined not to be read from the medium 3 in step S14, within the READ range present in the first cache 71 and the second cache 72. A hardware in the controller 2 automatically starts the transfer of the data read into the work area 70 and some data, which are determined not to be read from the medium 3 in step S14, within the READ range present in the first cache 71 or the second cache 72 to the host 1 (step S19). During this transfer, the controller 2 (CPU 4) determines whether the retry has occurred or not in the data readout in step S18 from the medium 3 to the work area 70 (step S20). When the retry has occurred (step S20: Yes), the controller 2 (CPU 4) sets retry information to the data (hereinafter also referred to as retried data), which is read into the work area 70 and on which the retry has occurred, on a sector basis (step S21). The retry information is specifically information indicating the fact that the retry has occurred during the data readout from the medium 3. The retry information may also include information such as a time which required for reading the data by the retry, or a number of times of retry until the data is finally read. Accordingly, to set the retry information may include the addition of the information indicating the fact that the retry has occurred on the retried data, as well as the situation in which the information, such as the time which required for reading the data by the read retry or the number of times of read retry until the data is finally read, is held and managed as information for a cache management separate from the retried data.

After step S21, the controller 2 (CPU 4) moves the retried data in the work area 70 to the second cache 72 (step S22). The detailed operation in step S22 is illustrated in the flowchart in FIG. 4. Firstly, the controller 2 (CPU 4) determines whether the retried data should be moved to the second cache 72 or not (step S31). The retried data is the data on which the retry has occurred during the readout from the medium 3, but the controller 2 (CPU 4) does not always have to move the retried data to the second cache 72. For example, when the time which required for reading the data by the retry is shorter than a predetermined time, or when the number of times of retry until the data is finally read is smaller than a predetermined number of times, the controller 2 (CPU 4) does not have to move the retried data to the second cache 72 (step S31: No). On the contrary, when the time which required for reading the data by the retry is equal to or longer than the predetermined time, or the number of times of retry until the data is finally read is equal to or larger than the predetermined number of times, the controller 2 (CPU 4) determines that the retried data should be moved to the second cache 72 (step S31: Yes). When the time which required for reading the data by the retry is longer or when the number of times of retry until the data is finally read is larger, compared with the retry information that is already held in the second cache 72, the controller 2 (CPU 4) may determine that the retried data should be moved to the second cache 72 (step S31: Yes), and in other cases, it may determine that the retried data should not be moved to the second cache 72 (step S31: No). When the controller 2 (CPU 4) determines that the retried data should not be moved to the second cache 72 (step S31: No), the process in step S22 in FIG. 3 is ended, and the controller 2 (CPU 4) moves to step S23. In this case, the retry information of the retried data that is determined not to be moved by the controller 2 (CPU 4) is invalidated. In other words, the setting of the retry information is canceled.

When it is determined that the retried data should be moved to the second cache 72 (step S31: Yes), the controller 2 (CPU 4) determines whether the retried data can be moved to the second cache 72 or not (step S32). Specifically, it is determined whether the second cache 72 has sufficient empty area or not. When the empty area in the second cache 72 is determined to be small so that the retried data, which is determined to be moved, cannot be moved (step S32: No), the controller 2 (CPU 4) invalidates the data having the oldest last access time in the second cache 72 until to be able to move new retried data (step S33). After step S33, and when the empty area in the second cache 72 is sufficient (step S32: Yes), the controller 2 (CPU 4) moves the retried data to the second cache 72 (step S34). Thereafter, the controller 2 (CPU 4) proceeds to step S23 in FIG. 3.

In step S23 in FIG. 3, the controller 2 (CPU 4) determines whether all data within the READ range are transferred to the host 1 or not. When there is the data that is not transferred to the host 1 within the READ range (step S23: No), the controller 2 (CPU 4) returns to step S18 to read the data, which is not yet transferred to the host 1, into the work area 70 from the medium 3. In this case, the data, which is already transferred to the host 1, in the work area 70 is overwritten. When all data within the READ range are transferred to the host 1 (step S23: Yes), the controller 2 (CPU 4) manages the data, which is not moved to the second cache 72, out of the data in the work area 70, as the data in the first cache 71 afterward (step S24).

There are cases in which the buffer 7 is the volatile memory, and the power supply to the storage device 100 is shut down with the data being stored in the first cache 71 or the second cache 72, or in which a spindle stop command (STOP UNIT COMMAND) for instructing to stop the spindle motor 30 is issued from the host 1 to the controller 2. In such cases, the controller 2 writes the data, which is stored in the first cache 71 or the second cache 72, into the medium 3 as temporary data. Upon the next power on, or upon the start of the spindle motor 30, the controller 2 reads and again writes the temporary data on both of or either one of the first cache 71 and the second cache 72. Thus, the buffer 7 can be recovered to the state before the power shutdown or before the stop of the spindle motor 30 occurs.

During an idle period when the controller 2 does not receive the command from the host 1, the controller 2 reads the data identical to the retried data stored in the second cache 72 from the medium 3. Specifically, the controller 2 tries to again read the data identical to the retried data stored in the medium 3. Thus, the controller 2 can examine whether the data can be read without the execution of the read retry.

During the idle period, the controller 2 tries to write the retried data stored in the second cache 72 on the medium 3, and to read this retried data. Thus, the controller 2 can examine whether the retried data can be read without the execution of the read retry.

When the controller 2 can read the retried data without the execution of the read retry in the examination described above, it is found that the retried data does not have to be stored in the second cache 72. Therefore, the retried data may be stored in the first cache 71.

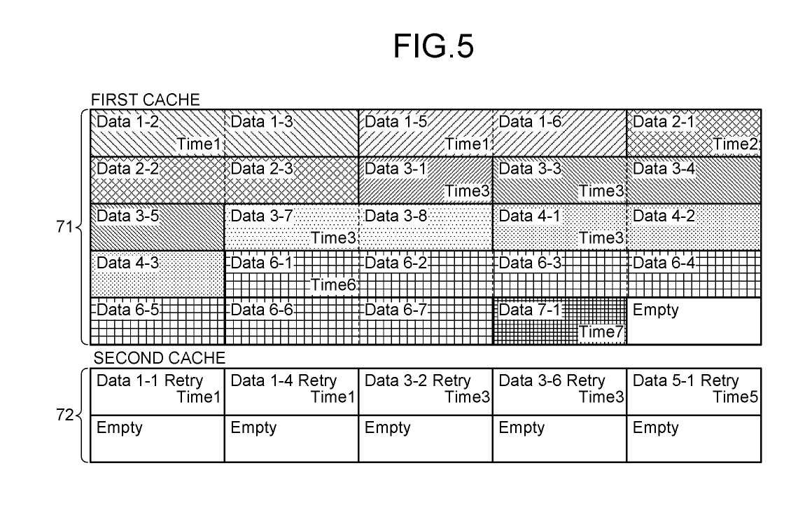

The cache control method according to the present embodiment in accordance with the flowcharts in FIGS. 3 and 4 will be described below more specifically with reference to FIGS. 5 to 8. The characteristic operations will be described in detail, and the description for the processes during the procedure will partly be skipped.

FIG. 5 illustrates the state in which the controller 2 receives the READ command seven times for different ranges from the host 1 with the data not being stored in the first cache 71 and the second cache 72 in the storage device 100 (step S10), and stores the data read from the medium 3 into the first cache 71 and the second cache 72. The data is illustrated in a sector unit.

The data read from the medium 3 by the first READ command are defined as Data 1-1 to Data 1-6, and the data read from the medium 3 by the second READ command are defined as Data 2-1 to Data 2-3, . . . . These data are stored in the first cache 71 and the second cache 72 as illustrated in FIG. 5. This situation corresponds to the case in which the process reaches step S18 through (step S11: No), (step S13: No), and (step S15: Yes).

The time when the Data 1-1 to Data 1-6 are read from the medium 3 is defined as Time 1, and the time when the Data 2-1 to Data 2-3 are read from the medium 3 is defined as Time 2, and so on. In this way, the last access time is managed (step S18). The last access time may be added to the head of the consecutive data collectively managed. “Retry” that is the information indicating that the retry information is stored since the retry has occurred (step S20: Yes) upon the readout of the Data 1-1 to Data 1-6 from the medium 3 is added to the Data 1-1 (retried data) and the Data 1-4 (retried data) in the second cache 72 (steps S21 and S22). Since the Data 1-1 and the Data 1-4 have the retry information, the data stored in the second cache 72 and managed by the second cache 72 is not stored in the first cache 71. Since the Data 1-4 is stored in the second cache 72, the Data 1-2 to Data 1-3 and the Data 1-5 to Data 1-6 stored in the first cache 71 out of Data 1-1 to Data 1-6 read from the medium 3 by the first READ command are not consecutive. Therefore, they are individually managed. The similar management is made for the second and the following READ commands.

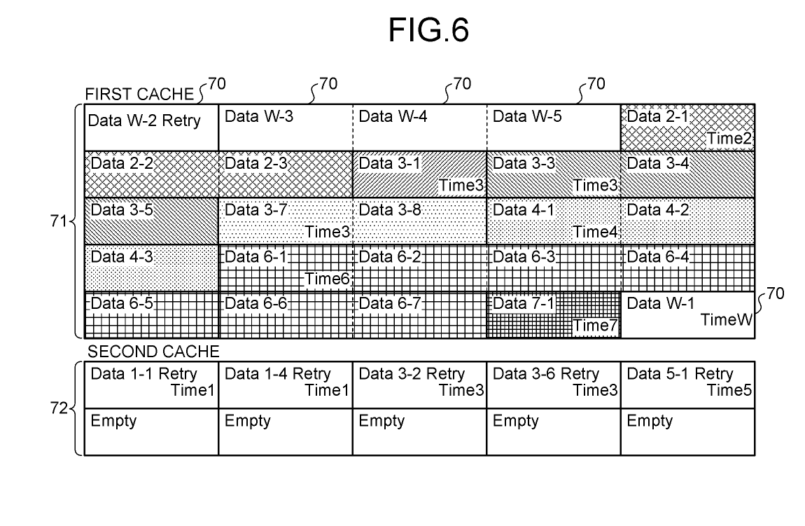

FIG. 6 illustrates the first cache 71 and the second cache 72 in the state in which the controller 2 receives the eighth READ command for the range different from the ranges for the first to seventh READ commands from the host 1. FIG. 6 illustrates the state of the first cache 71 and the second cache 72 just after some data in the first cache 71 are invalidated (step S16) to secure the work area 70 in the first cache 71 (step S17), and the data is read into the work area 70 from the medium 3 (step S18).

Since the work area 70 cannot be secured in the first cache 71 only by the empty area in the first cache 71 in FIG. 5 in the eighth READ command (step S15: No), the Data 1-2 to Data 1-3 and Data 1-5 to Data 1-6, which have the oldest access time in the first cache 71, are invalidated in order to secure the work area 70 (step S16). The data read from the medium 3 are illustrated as Data W-1 to Data W-5 in the work area 70 secured by the data invalidation. “Retry” that is the information indicating that the retry information is stored since the retry occurs (step S20: Yes) in the sector corresponding to the Data W-2 upon reading the data from the medium 3 onto the work area 70 is added to the Data W-2 (retried data) in the first cache 71 (step S21). As illustrated in FIG. 6, the work area 70 is a ring buffer with a variable length, for example, and the area other than the work area 70 in the first cache 71 is also managed by the ring buffer.

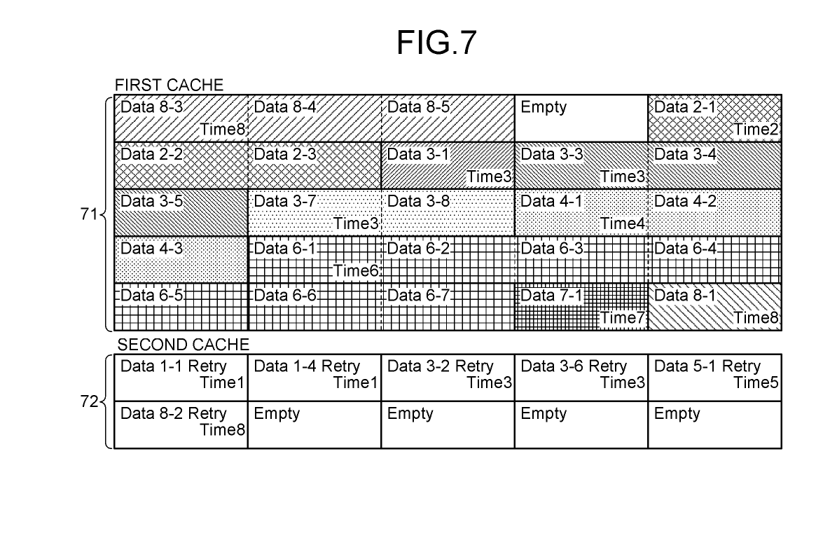

FIG. 7 illustrates the state of the first cache 71 and the second cache 72 when the Data W-1 to Data W-5 in the work area 70 are transferred to the host 1 (step S19), and then, the Data W-1 to Data W-5 are managed as Data 8-1 to Data 8-5 that are cache data (steps S22 and S24).

The Data W-2 (retried data) in the sector where the retry has occurred upon reading the data from the medium 3 by the eighth READ command is stored in the second cache 72 as Data 8-2 (retried data) (step S22). FIG. 7 illustrates the case where the Data W-2 is determined to be moved to the second cache 72 (step S31: Yes), and the second cache 72 has sufficient empty area (step S32: Yes) in FIG. 4. However, as described above, there may be the case where it is determined that the Data W-2 should not be moved to the second cache 72 based upon the retry information (step S31: No). The Data W-1 and Data W-3 to Data W-5 having no retry information are stored in the first cache 71 as Data 8-1 and Data 8-3 to Data 8-5 (step S24). The Data 8-1 and Data 8-3 to 8-5 are non-consecutive data in the first cache 71, so that they are managed as individual cache data. The area in the first cache 71 where the Data W-2 is present in FIG. 6 becomes an empty area, since the Data W-2 is stored in the second cache 72 as the Data 8-2. Therefore, the Data 8-3 to Data 8-5 are stored close together in this area.

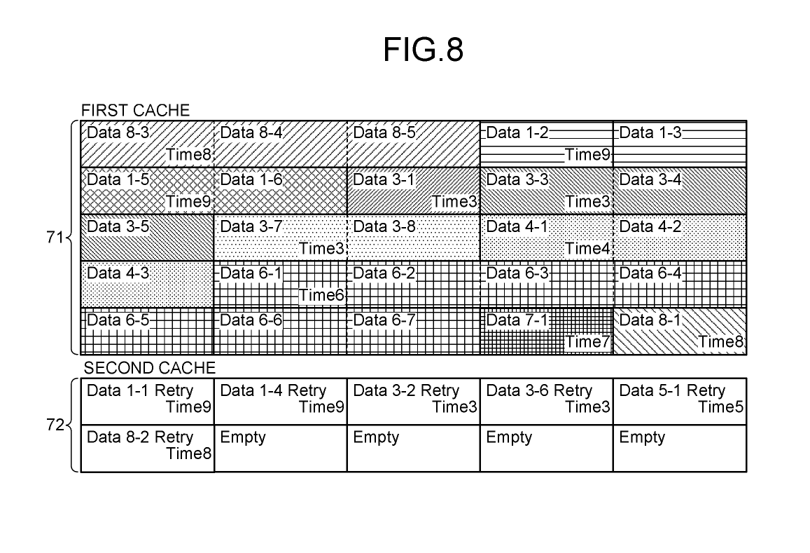

FIG. 8 illustrates the state of the first cache 71 and the second cache 72 after the controller 2 again receives the READ command from the host 1 for the read range (Data 1-1 to Data 1-6) by the first READ command in the state of FIG. 7, and the storage device 100 transfers the data within the read range to the host 1.

The work area 70 cannot be secured only by the empty area in the first cache 71 (step S15: No) in the state of FIG. 7. Therefore, the Data 2-1 to Data 2-3 having the oldest access time in the first cache 71 are invalidated (step S16) to generate the work area 70 in the first cache 71 (step S17), and the Data 1-2 to Data 1-3 and the Data 1-5 to Data 1-6 not stored in the second cache 72 are read to the work area 70 from the medium 3 (step S18). Thereafter, the Data 1-1 and Data 1-4 in the second cache 72 and the Data 1-2 to Data 1-3 and Data 1-5 to Data 1-6 in the work area 70 are transferred to the host 1 (step S19). Thus, the state in FIG. 8 is established. In this case, since the readout is executed for the Data 1-1 and Data 1-4 in the second cache 72, the last access time of the Data 1-1 and the Data 1-4 is updated to Time 9 (step S14). The Data 1-2 to Data 1-3 and the Data 1-5 to Data 1-6 read on the work area 70 are stored and managed in the first cache 71 (step S24).

When the first cache 71 has no empty area, the data in the first cache 71 is basically invalidated from the older data. However, as described above, the retried data having the last access time older than the data with the oldest last access time in the first cache 71 can be left in the buffer 7 by separately managing the retried data preferentially.

When a write instruction to the data in the first cache 71 and the second cache 72 is issued from the host 1, the data in the first cache 71 and the second cache 72 is updated. Thereafter, the updated data is written onto the medium 3.

As described above, in the present embodiment, the second cache 72 that makes management in consideration of the retry information is provided in the buffer 7 in addition to the first cache 71. The method of arranging the first cache 71 and the second cache 72 in the buffer 7 is not limited to the method described in the present embodiment.

The second cache 72 may not physically be provided, and in order to realize the cache control same as that described above, it may be configured such that the retried data on which the retry has occurred takes priority up to a certain data amount separate from the other data, and this retried data is managed, by using a single cache area in consideration of the retry information. In this case, it is unnecessary to move the data (retried data) on which the retry information is set in the work area 70 to the second cache 72, so that the process in step S34 in FIG. 4 becomes unnecessary. Therefore, the controller 2 only makes a deletion of the old retried data and the invalidation of the set retry information.

In the case where the controller receives again the READ command for the read range by the first READ command in the state of FIG. 7 with the buffer 7 being provided with only the first cache 71 as in the background art, the Data 1-1 to Data 1-6 have to be read onto the work area. If the retry occurs upon the readout from the medium 3, performance is deteriorated.

However, in the present embodiment, the area (e.g., second cache 72) that preferentially manages the retried data on which the retry has occurred is provided in the buffer 7. Therefore, the retried data in the second cache 72 can be used for the second readout. Thus, the occurrence of the read retry due to the readout from the medium 3 is prevented to enhance the data readout performance of the storage device 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cache control method of a storage device including a storage unit that stores data, and a buffer memory having a first cache area and a second cache area serving as a cache of the storage unit, the method comprising:
storing data read from the storage unit in the first cache area in response to a read command from a host;
moving retried data, on which a read retry has occurred upon the readout from the storage unit, to the second cache area from the first cache area in order that the retried data amount in the second cache area is not more than a predetermined data amount; and
transferring data in the first cache area or the second cache area to the host.

2. The cache control method according to claim 1, further comprising:
setting retry information including information indicating that the read retry has occurred on the retried data, and information related to the read retry; and
determining whether the retried data is moved from the first cache area to the second cache area based upon the retry information.

3. The cache control method according to claim 2, wherein
the retry information includes a time which required for reading the retried data.

4. The cache control method according to claim 2, wherein
the retry information includes a number of times of the read retry until the retried data is read.

5. The cache control method according to claim 3, wherein
the retry information includes a number of times of the read retry until the retried data is read.

6. The cache control method according to claim 2, further comprising:
determining whether the retried data is moved to the second cache area based upon the retry information of the retried data that is already held in the second cache area.

7. The cache control method according to claim 2, further comprising:
canceling the retry information of the retried data, when it is determined that the retried data is not moved to the second cache area from the first cache area.

8. The cache control method according to claim 1, further comprising:
invaliding the retried data already held in the second cache area in the order from the retried data having an older read time, before the retried data is moved from the first cache area to the second cache area.

9. A storage device comprising:
a storage unit that stores data;
a buffer memory including a first cache area and a second cache area serving as a cache of the storage unit; and
a controller that stores data read from the storage unit in the first cache area in response to a read command from a host, wherein
the controller moves retried data, on which a read retry has occurred upon the readout from the storage unit, to the second cache area from the first cache area in order that the retried data amount in the second cache area is not more than a predetermined data amount, and transfers data in the first cache area or the second cache area to the host.

10. The storage device according to claim 9, wherein
the controller sets retry information including information indicating that the read retry has occurred on the retried data, and information related to the read retry, and determines whether the retried data is moved from the first cache area to the second cache area based upon the retry information.

11. The storage device according to claim 10, wherein
the retry information includes a time which required for reading the retried data.

12. The storage device according to claim 10, wherein
the retry information includes a number of times of the read retry until the retried data is read.

13. The storage device according to claim 11, wherein
the retry information includes a number of times of the read retry until the retried data is read.

14. The storage device according to claim 10, wherein
the controller determines whether the retried data is moved to the second cache area based upon the retry information of the retried data that is already held in the second cache area.

15. The storage device according to claim 10, wherein
the controller cancels the retry information of the retried data, when it is determined that the retried data is not moved to the second cache area from the first cache area.

16. The storage device according to claim 9, wherein
the controller invalidates the retried data already held in the second cache area in the order from the retried data having an older read time, before the retried data is moved from the first cache area to the second cache area.

17. The storage device according to claim 9, wherein
when detecting a power supply shutdown with data in the first cache area and the second cache area being stored in volatile memory, the controller writes the data in the first cache area and the second cache area on non-volatile memory or on the storage unit as temporary data, and upon a next power activation or upon a start of a spindle motor, reads the temporary data on both of or either one of the first cache area and the second cache area.

18. The storage device according to claim 9, wherein
when receiving a command of stopping a spindle motor issued from the host with data in the first cache area and the second cache area being stored in volatile memory, the controller writes the data in the first cache area and the second cache area on non-volatile memory or on the storage unit as temporary data, and upon a next power activation or upon a start of a spindle motor, reads the temporary data on both of or either one of the first cache area and the second cache area.

19. The storage device according to claim 9, wherein
the controller examines whether data that is identical to the retried data and is stored in the second cache area can be read or not without the execution of the read retry during an idle time when the controller does not receive a command from the host.

20. The storage device according to claim 9, wherein
the controller examines whether data that is identical to the retried data and is stored in the second cache area can be written on the storage unit, and just after that, this data can be read from a medium without the execution of the read retry during an idle time when the controller does not receive a command from the host.
